(19) United States
(12) Patent Application Publication
(10) Pub. No.: US 2020/0196798 A1
(43) Pub. Date: Jun. 25, 2020

(54) Smoker Apparatus for Burner Grill

(71) Applicant: The Boltz Group, LLC, Addison, TX (US)

(72) Inventors: Erica Lea Boltz, Dallas, TX (US); Bradley Gleaton, Dallas, TX (US); Randall May, Addison, TX (US)

(73) Assignee: The Boltz Group, LLC, Addison, TX (US)

(21) Appl. No.: 16/229,041

(22) Filed: Dec. 21, 2018

(51) Int. Cl. A47J 37/07; A23B 4/052

(52) U.S. Cl. CPC A47J 37/0786; A23B 4/052; A47J 37/0713

(57) ABSTRACT

Disclosed are smoker apparatuses that are selectively insertable into and removable from a burner grill. The removable smoker apparatuses can comprise a body including an outer wall defining an internal cavity. The body can comprise a plurality of slits disposed within the outer wall. The removable smoker apparatuses can further comprise a door attached to a first end of the body via a hinge member, the door configured to transition the smoker apparatus from an open configuration to a closed configuration. The removable smoker apparatus can also comprise a hook attached to a second end of the body, the hook configured to removably couple with a receiving portion of the burner grill.

### FIELD OF THE TECHNOLOGY

The presently disclosed technology is directed to a smoker apparatus and more particularly a smoker apparatus that is insertable and removable from a burner grill.

### BACKGROUND

Smoking is a well-known and popular means for preparing food where the food is exposed to smoke for cooking, flavoring, and/or preserving. Smoke is created from burning or smoldering material, most often wood, and typically applied to food in a controlled environment such as a smoker oven, smoke-roaster, closed wood-fired oven, barbecue pit, or smokehouse. Burner grills are also a well-known and popular device for preparing food in which the food is prepared by applying heat from below. While there are specialized devices that may be used to smoke food, it is also desirous for burner grills to be selectively manipulated from their original purpose to provide smoke cooking or flavoring capabilities.

Embodiments of the presently disclosed technology are directed to these and other considerations.

### SUMMARY

Embodiments of the presently disclosed technology comprise a removable smoker apparatus for a burner grill. The removable smoker apparatus can comprise a body including an outer wall defining an internal cavity. The body can comprise a plurality of slits disposed within the outer wall. The removable smoker apparatus may further comprise a door attached to a first end of the body via a hinge member, the door configured to transition the smoker apparatus from an open configuration to a closed configuration. In some embodiments, the smoker apparatus may comprise a hook attached to a second end of the body, the hook configured to removably couple with a receiving portion of the burner grill.

Embodiments of the presently disclosed technology can comprise a removable smoker apparatus for a burner grill comprising a cylindrical body. The cylindrical body can comprise an internal cavity for receiving a smoking material and a plurality of slits disposed within and providing openings through an outer wall of the cylindrical body. The smoker apparatus may also comprise a door selectively rotatable via a hinge member affixing the door to a first end of the cylindrical body and a hook attached to a second end of the cylindrical body, the hook configured to couple with a receiving portion of the burner grill. The door may comprise the hook, or the hook may be independent of the door.

Embodiments of the presently disclosed technology can comprise a removable smoker apparatus for a burner grill comprising a body comprising an outer wall and an internal cavity and a plurality of slits disposed through an outer wall of the body. The smoker apparatus may further comprise a door attached to a first end of the body, the door configured to transition from an open configuration to a closed configuration such that when the door is in an open configuration the internal cavity is at least partially exposed. The smoker apparatus may additionally comprise a hook attached to a second end of the body, the hook configured to removably couple with the burner grill.

### BRIEF DESCRIPTION OF THE DRAWINGS

FIG. 1A is a perspective view of a smoker apparatus in an open configuration, according to some embodiments of the presently disclosed technology.

FIG. 1B is a perspective view of a smoker apparatus in a closed configuration, according to some embodiments of the presently disclosed technology.

FIG. 2A is a front view of a smoker apparatus having a door in an open configuration, according to some embodiments of the presently disclosed technology.

FIG. 2B is a front view of a smoker apparatus having a door in a closed configuration, according to some embodiments of the presently disclosed technology.

FIG. 3A is a top view of a smoker apparatus having a plurality of slits, according to some embodiments of the presently disclosed technology.

FIG. 3B is a bottom view of a smoker apparatus having a plurality of slits, according to some embodiments of the presently disclosed technology.

FIG. 3C is side top view of a smoker apparatus having a plurality of slits, according to some embodiments of the presently disclosed technology.

FIG. 4 is a back view of a smoker apparatus comprising a hook, according to some embodiments of presently disclosed technology.

FIG. 5 is an illustration of a smoker apparatus disposed within a burner grill environment, according to some embodiments of the presently disclosed technology.

### DETAILED DESCRIPTION

Embodiments of the presently disclosed technology include removable smoker apparatuses for use in burner grills to provide smoke taste or flavor to food. To facilitate an understanding of the principles and features of the various embodiments of the disclosure, various illustrative embodiments are explained below. Although exemplary embodiments of the disclosure are explained in detail, other embodiments are contemplated. Accordingly, it is not intended that the disclosure is limited in its scope to the details of construction and arrangement of components set forth in the following description or examples. The disclosure is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an,” and “the” include plural references unless the context clearly dictates otherwise. As used herein, the term “and/or” may mean “and,” it may mean “or,” it may mean “exclusive-or,” it may mean “one,” it may mean “some, but not all,” it may mean “neither,” and/or it may mean “both.” The term “or” is intended to mean an inclusive “or.”

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose. It is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

From time-to-time, the presently disclosed embodiments are described herein in terms of example environments. Description in terms of these environments is provided to allow the various features and embodiments to be portrayed in the context of an exemplary application. After reading this description, it will become apparent to one of ordinary skill in the art how the various embodiments can be implemented in different and alternative environments.

Unless defined otherwise, all technical and scientific terms used herein have the same meaning as is commonly understood by one of ordinary skill in the art to which the embodiments of this disclosure belong. The terms “comprising,” “including,” and “containing” are intended to be open-ended.

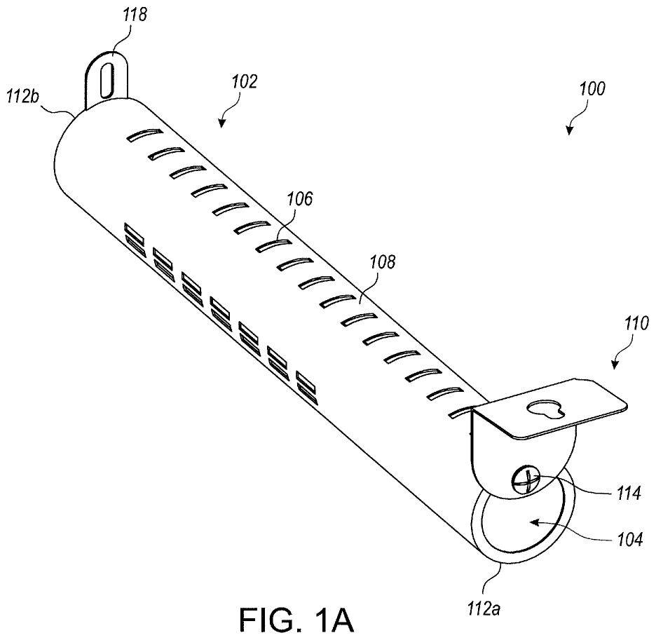

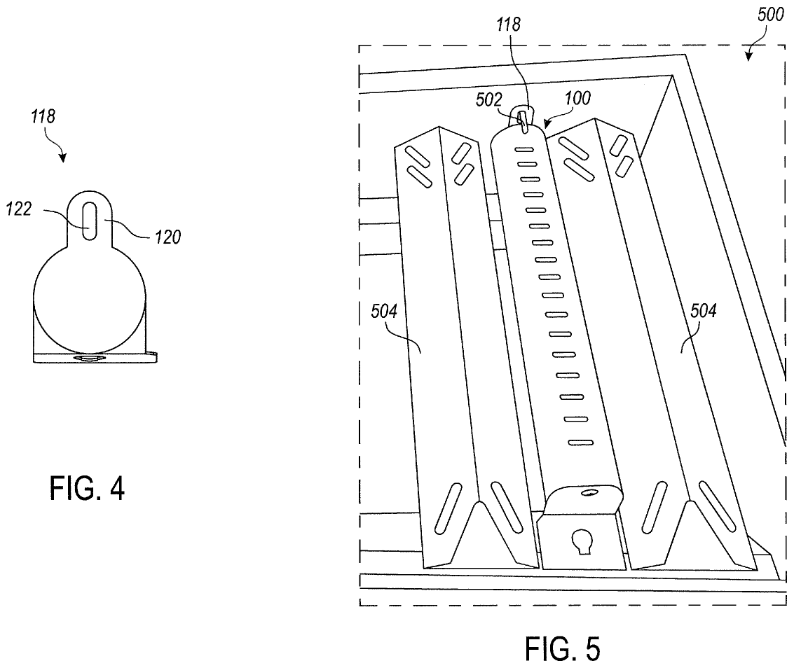

FIGS. 1A and 1B are illustrations of an example embodiment of a smoker apparatus 100 having a tubular shape and configured to be removably integrated within a burner grill, as discussed below with respect to FIG. 5. FIG. 1A is an illustration of an example embodiment of the smoker apparatus 100 in an open configuration, and FIG. 1B is an illustration of an example embodiment of the smoker apparatus 100 in a closed configuration. It is understood that the smoker apparatuses 100 disclosed herein can be adapted to be opened and closed to accommodate filling with smoking materials and substantially enclosing the smoking materials, during use of the grill. It is also understood that while the smoker apparatuses 100 disclosed herein are described to be tubular in shape, the size and shape may be adapted for use in burner grills having varying configurations, including burner grills having heating elements of various shapes, sizes, or positioning within the grill.

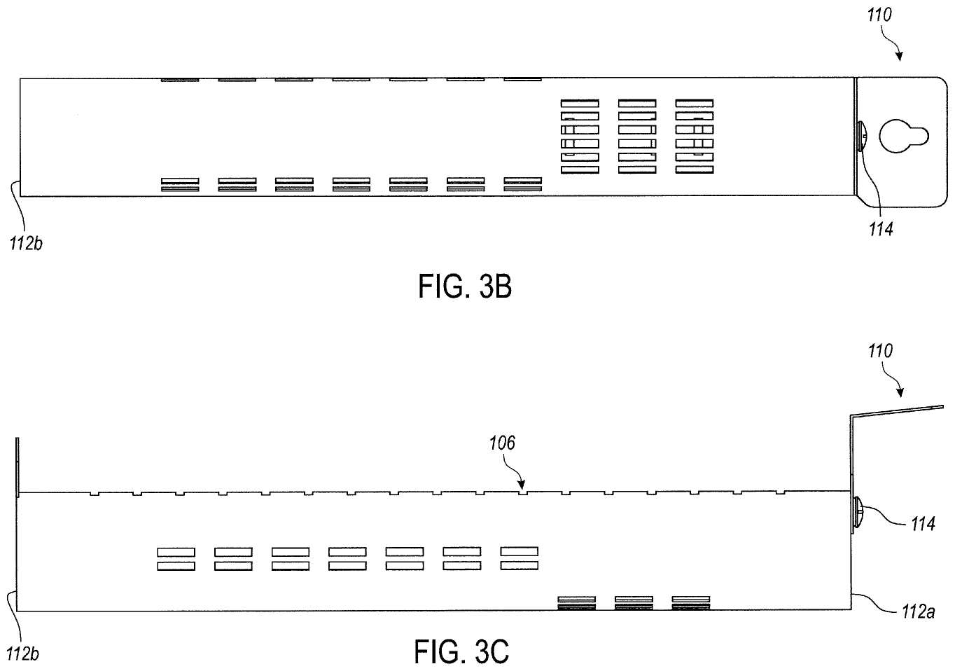

FIGS. 1A and 1B are illustrations showing a perspective view of the smoker apparatus 100 in an open configuration (FIG. 1A) and a closed configuration (FIG. 1B). As shown in FIG. 1A, the smoker apparatus 100 can include a body 102 comprising an outer wall 108 defining a cavity 104 into which smoking materials may be placed and substantially enclosed. The body 102 can be decorated with a plurality of slits 106 disposed within and through the outer wall 108 of the body 102. A door 110 can be affixed to a first end 112a of the body 102 via a hinge member 114 to allow for selectively opening and closing the smoker apparatus 100. In some embodiments, as illustrated in FIGS. 1A and 1B, the smoker apparatus 100 can further comprise a hook 118 attached to a second end 112b of the body 102 for removably coupling the smoker apparatus 100 to the burner grill (not shown), the burner grill having a corresponding projection (not shown) onto which hook 118 may be detachably coupled. These features of the hook 118 and burner grill are discussed in greater detail with respect to FIGS. 4 and 5.

In some embodiments, the body 102 may generally comprise an elongated and elliptical/cylindrical shape, as illustrated in FIGS. 1A and 1B, to accommodate grill racks and/or other heating surface or devices, such as flavorizer bars. Likewise, it is also contemplated that the smoker apparatus 100 may be other shapes and sizes to accommodate filling with smoking materials or fitting between the heating surfaces or devices, including other prismed shapes (e.g., prismatic boxes, spheres, or obloids). Additionally, in other embodiments, body 102 may be approximately cylindrical and for instance comprise one or more flattened surfaces. Smoker apparatus 100 can be formed from any materials that are resilient to cooking conditions, including temperatures over 200 degrees Fahrenheit and/or direct flame exposure. For example, smoker apparatus 100 may be formed of a high-temperature glass, iron, steel alloy, aluminum, or ceramic composite.

The body 102 can comprise a cavity 104 into which smoking materials may be placed and substantially enclosed. In some embodiments, the cavity 104 can extend the entire length of the body 102. In other embodiments, the cavity 104 can extend only a portion of the length of the body 102. The cavity 104 can be any shape and any size so long as it can contain the smoking materials (e.g. woodchips or pellets).

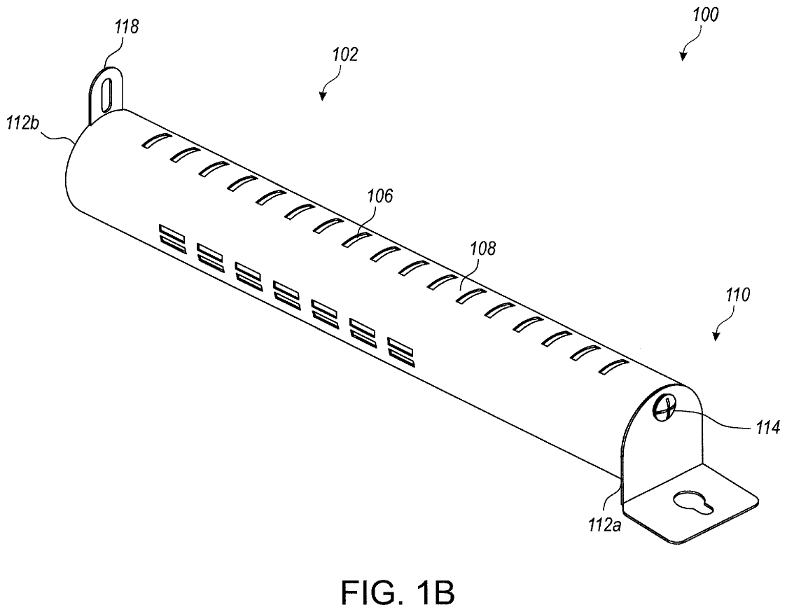

The smoker apparatus 100 can comprise a door 110 configured to transition the smoker apparatus 100 from an open configuration (as illustrated for instance in FIG. 2A) to a closed configuration (as illustrated for instance in FIG. 2B). The door 110 can be affixed to the first end 112a of the body 102 via the hinge member 114. For instance, the first end 112a may comprise a planar surface 113 disposed about a perimeter of an inlet to the internal cavity 104. The hinge member 114 may therefore affix the door 110 to the planar surface 113 of the first end 112a.

In some embodiments, as illustrated in FIGS. 2A and 2B, the door 110 can comprise a lever 116 for rotating the door 110 with respect to the body 102 and about the hinge member 114. Those skilled in the art would understand that the hinge member 114 would act as a fulcrum for the rotating door 110. By rotating the door 110 with respect to the first end 112a of the body 102 as indicated by “r” in FIG. 2A, the smoker apparatus 100 can be transitioned from the open configuration illustrated in FIG. 2A to the closed configuration illustrated in FIG. 2B. The door 110 can be rotated in one or both of a clockwise or a counterclockwise direction. In some embodiments, the door 110 may have an angle of rotation of 360 degrees. In other embodiments, the door 110 or may be designed to limit the angle of rotation, depending on the type of hinge member 114 used.

In some embodiments, the door 110 may further comprise an aperture disposed through the lever 116. The aperture may allow for the door 110 to be hung on a corresponding peg, such as a screw, affixed to an outer surface of the burner grill or a cart for transporting the burner grill. This mechanism would allow the smoker apparatus 100 to be stored in association with the burner grill when it is removed or otherwise not in use.

In some embodiments, the hinge member 114 can comprise a pin about which the door 110 can be rotated. For instance, as illustrated in FIGS. 2A and 2B, the hinge member 114 can comprise a screw. In some embodiments, the screw can be a shoulder bolt that can be tightened down to a predetermined distance to cause friction on the door 110. While the smoker apparatus 100 is illustrated as being rotatably hinged, it is also understood that other hinge mechanisms (e.g., a rivet) may be included such that the smoker apparatus 100 can be opened and closed as desired.

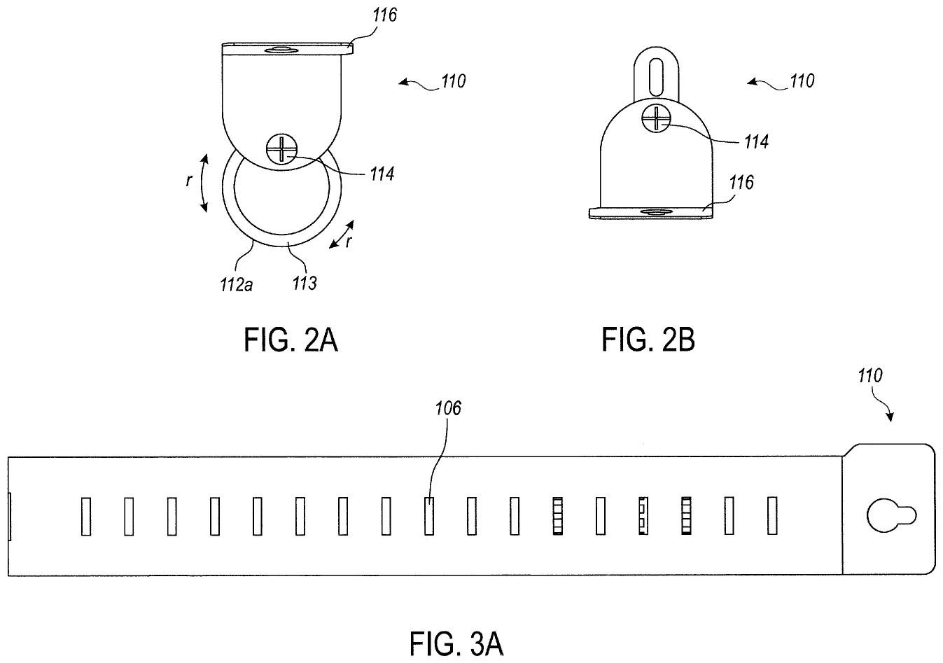

The body 102 can be decorated with a plurality of slits 106 disposed within the outer wall 108 of the body 102. FIGS. 3A-3C show various types and positions of slits 106 disposed within and through the outer wall 108 of the body 102. In some embodiments, the slits 106 can be small openings through the outer wall 108 of the body 102 that allow air to pass from outside the body 102 to the cavity 104. This can therefore allow heat to ignite the smoking material and tend to prevent the smoking material from burning with an open flame. The slits 106 can be located on various portions of the outer wall 108. For instance, as illustrated in FIG. 3A, the slits 106 can be located along a top portion of the outer wall 108. Additionally, in some embodiments, the slits 106 can additionally be located on a side portion and/or a bottom portion of the outer wall 108, as illustrated in FIGS. 3B and 3C. It is also understood that any number or pattern of slits 106 may be utilized in the smoker apparatus 100.

The smoker apparatus 100 can be adapted for use in a burner grill 500, as illustrated in FIG. 5. The burner grill 500 may be any conventional gas or charcoal grill, including four- and five-burner grills. The smoker apparatus 100 can be particularly useful to slow cook meat (e.g., chicken, ribs, pork shoulder) in which a user would like to add smoke flavor. In some embodiments, when in use in a burner grill 500, the smoker apparatus 100 may be placed underneath the grates (not shown) of the burner grill 500 proximate a heat source (not shown) and between the heat tent structures 504 such that the smoking material within the smoker apparatus 100 may ignite. In some embodiments, it may not be desirable for the smoker apparatus 100 to be present in the burner grill 500 at all times and thus the smoker apparatus 100 may be removable, for instance via the hook 118. The hook 118 may interface or couple with a receiving portion 502 disposed on an interior side wall of the burner grill 500. The placement of the smoke

FIG. 4 illustrates an example embodiment of the hook 118. The hook 118 may be a tab 120 with an aperture 122 and be affixed to the second end 112b of the body 102. As illustrated in FIG. 5, the receiving portion 502 may be a correspondingly shaped rod configured to be inserted through the aperture. While these structures are explicitly disclosed, it is understood that the hook 118 and receiving portion 502 may form various connections including but not limited to corresponding slotted structures through which the smoker apparatus 100 can be slid into and locked to the burner grill 500, hooks and receiving portions having other shapes and sizes to facilitating coupling between the smoker apparatus 100 and the burner grill 500.

As illustrated in FIG. 5, when disposed within a burner grill 500, the smoker apparatus 100 can be positioned between and parallel to the heat tent structures 504, according to some embodiments of the presently disclosed technology. The smoker apparatus 100 can couple via the hook 118 to a receiving portion 502 which can be disposed on an internal surface of the burner grill 500. Additionally, when the smoker apparatus 100 is disposed within the burner grill 500, the lever 116 of the door 110 can rest upon a ledge disposed within the burner grill 500, as illustrated in FIG. 5. The ledge portion can be the same ledge on which the heat tent structures 504 rest. As such, in some embodiments, the smoker apparatus 100 can be approximately the same length as the heat tent structures 504 such that the smoker apparatus 100 can span the burner grill 500 from front to rear.

When the smoker apparatus 100 is positioned within the burner grill 500, the smoker apparatus 100 can be positioned such that the slits (and more particularly slits disposed on the bottom and/or side) can allow the smoking material to produce smoke when heated by the gas burner within a fairly short period of time (e.g., from approximately 5 to 10 minutes). Once the smoking material starts smoking, smoke can exhaust out the top and side slits and sometimes the bottom slits. In some embodiments, once the smoking material starts smoking, the gas burner or burners near the smoker apparatus 100 may be turned off (usually to allow the smoking material to smoke for longer periods of time). If the smoking material stops smoking after a period of time, the burners can be relighted to start smoking again.

1. A removable smoker apparatus for a burner grill comprising:
a body comprising an outer wall defining an internal cavity;
a plurality of slits disposed within the outer wall;
a door attached to a first end of the body via a hinge member, the door configured to transition from an open configuration to a closed configuration; and
a hook attached to a second end of the body, the hook configured to removably couple with a receiving portion of the burner grill.

2. The smoker apparatus of claim 1 wherein the body is tubular in shape.

3. The smoker apparatus of claim 1 wherein the plurality of slits are disposed lengthwise across a top portion of the body.

4. The smoker apparatus of claim 3 wherein the plurality of slits are disposed on at least one side portion of the body and at least a bottom portion of the body.

5. The smoker apparatus of claim 1 wherein the door is rotatable about the hinge member from the closed configuration to the open configuration.

6. The smoker apparatus of claim 1 wherein the door comprises a lever configured to rotate the door about the hinge member.

7. The smoker apparatus of claim 1 wherein the hinge member comprises a screw configured to affix the door to the body.

8. The smoker apparatus of claim 7 wherein the first end of the body comprises a planar surface disposed about an inlet of the internal cavity and the hinge member is configured to affix the door to the planar surface.

9. The smoker apparatus of claim 1 wherein the hook is a tab comprising an aperture disposed proximate a central portion of the tab.

10. A removable smoker apparatus for a burner grill comprising:
a cylindrical body comprising an outer wall defining an internal cavity, the internal cavity for receiving a smoking material and the cylindrical body comprising a plurality of slits disposed within the outer wall of the cylindrical body;
a hinge member affixing a door to a first end of the cylindrical body, the door selectively rotatable via the hinge member; and
a hook attached to a second end of the cylindrical body, the hook configured to couple with a receiving portion of the burner grill.

11. The smoker apparatus of claim 10 wherein the plurality of slits are disposed lengthwise across a top portion of the body.

12. The smoker apparatus of claim 11 wherein the plurality of slits are disposed on at least one side portion of the body and at least a bottom portion of the body.

13. The smoker apparatus of claim 10 wherein the door is rotatable about the hinge member from a closed configuration to an open configuration.

14. The smoker apparatus of claim 10 wherein the door comprises a lever configured to rotate the door about the hinge member.

15. The smoker apparatus of claim 10 wherein the hinge member comprises a screw configured to affix the door to the body.

16. The smoker apparatus of claim 10 wherein the first end of the body comprises a planar surface disposed about an inlet to the internal cavity and the hinge member is configured to affix the door to the planar surface.

17. The smoker apparatus of claim 10 wherein the hook is a tab comprising an aperture disposed proximate a central portion of the tab.

18. A removable smoker apparatus for a burner grill comprising:
a body comprising an outer wall and an internal cavity and a plurality of slits disposed within the outer wall of the body;
a door attached to a first end of the body, the door configured to transition from an open configuration to a closed configuration; and
a hook attached to a second end of the body, the hook configured to removably couple with the burner grill;
wherein when the door is in an open configuration, at least a portion of the internal cavity is exposed.

19. The smoker apparatus of claim 18 further comprising a hinge member affixing the door to the body, wherein the door comprises a lever configured to rotate the door about the hinge member.

20. The smoker apparatus of claim 19 wherein the first end of the body comprises a planar surface disposed about an inlet to the internal cavity and the hinge member is configured to affix the door to the planar surface.
